(19) United States
(12) Patent Application Publication
(10) Pub. No.: US 2007/0097911 A1
(43) Pub. Date: May 3, 2007

(54) Unifying multi-MCS-multi-receiver aggregation (MMRA) and single-MCS-multi-receiver aggregation (SMRA) for IEEE 802.11n standard

(75) Inventors: Xuemei Ouyang, San Jose, CA (US); Chiu Ngo, San Francisco, CA (US)

Correspondence Address: Kenneth L. Sherman, Esq.;Myers Dawes Andras & Sherman, LLP, 11 TH Floor, 19900 MacArthur Blvd., Irvine, CA, 92612, US

(73) Assignee: Samsung Electronics Co., Ltd., Suwon City (KR)

(21) Appl. No.: 11/264,079

(22) Filed: Oct. 31, 2005

(51) Int. Cl. H04Q 7/00; H04J 3/16

(52) U.S. Cl. 370/329; 370/466

(57) ABSTRACT

A method of communicating data over a wireless local area network according to an IEEE 802.11 standard for unifying Multi-MCS-Multi-Receiver Aggregation (MMRA) and Single-MCS-Multi-Receiver Aggregation (SMRA), the improvement including modifying SMRA format such that MMRA treats SMRA as a special case of MMRA, thereby unifying SMRA and MMRA.

### FIELD OF THE INVENTION

The present invention relates generally to data communication, and more particularly, to data communication in wireless local area networks (WLAN).

### BACKGROUND OF THE INVENTION

In IEEE 802.11n development process, a Multi-MCS-Multi-Receiver Aggregation (MMRA) mechanism has been proposed to increase the wireless LAN (WLAN) efficiency.

Conventionally, MMRA and Single-MCS-Multi-Receiver Aggregation (SMRA) are treated as two independent communications mechanisms. Conventional solutions require at least two bits in the HT-SIG field of the PLCP Protocol Data Unit (PPDU) format to indicate the SMRA or MMRA. However, the HT-SIG field is running out of bits. Thus, there is a need for a method to unify SMRA and MMRA to save a bit from indicating SMRA and MMRA.

### BRIEF SUMMARY OF THE INVENTION

In one embodiment, the present invention provides a method to unify SMRA and MMRA to save a bit from indicating SMRA and MMRA.

As such, according to one embodiment of the present invention, in a method of communicating data over a wireless local area network according to a developing IEEE 802.11n standard for unifying Multi-MCS-Multi-Receiver Aggregation (MMRA) and Single-MCS-Multi-Receiver Aggregation (SMRA), the improvement comprises modifying SMRA format such that MMRA treats SMRA as a special case of MMRA, thereby unifying SMRA and MMRA.

The modification method further includes the steps of providing a modified PPDU format with MMRA signaling wherein in the modified PPDU format, HT-SIG-MMRA is placed at the end of HT-LTF, whereby the original HT-SIG format described in S.A. Mujtaba, “TGn Sync Proposal Technical Specification,” a contribution to IEEE.802.11, 11-04-889r1, November 2004, (incorporated herein by reference) is preserved while accommodating the variable length of HT-SIG-MMRA.

The modification step further includes the steps of using AGGRAGATION bit in HT-SIG such that it is used to indicate MRA, whether or not the operation is SMRA or MMRA. In addition, SMRA is moved from MAC layer to PHY layer, placed in the HT-SIG-MMRA Part, whereby SMRA is treated as a special case of MMRA which is a MMRA with only one Modulation and Coding Set, MCS, set.

These and other features, aspects and advantages of the present invention will become understood with reference to the following description, appended claims and accompanying figures.

### BRIEF DESCRIPTION OF THE DRAWINGS

FIG. 1 shows a SMRA transmission format.

FIG. 2 shows a MRAD MPDU transmission format.

FIG. 3 shows a MMRA transmission format.

FIG. 4 shows a HT-SIG-MMRA Part transmission format.

FIG. 5 shows a PPDU format with MMRA signaling according to an embodiment of the present invention.

FIG. 6 shows a HT-SIG transmission format.

FIG. 7 shows HT-SIG MMRA Part and where SMRA moved from MAC layer to PHY layer, where it is placed in the HT-SIG-MMRA Part, according to an embodiment of the present invention.

### DETAILED DESCRIPTION OF THE INVENTION

In one embodiment, the present invention provides a method to unify SMRA and MMRA to save a bit from indicating SMRA and MMRA.

Initial 802.11 stations typically send frames in the order they are received. For throughput purposes, it is highly desirable to reorder frames so that they can coalesce into larger aggregated frames. Aggregation in TGnSync is a MAC-layer function that bundles several MAC frames into a single PLCP (Physical Layer Convergence Protocol) frame for transmission.

A single physical-layer frame contains several MAC layer frames. Several MAC frames are put into the same PLCP frame, with an appropriate delimiter between them. The delimiter has a small reserved field, a length field for the following MAC frame, a CRC to protect the delimiter, and a unique pattern to assist in recovering individual frames from the aggregate. MAC frames are put into the aggregate without modification, and contain the full header and MAC CRC. Even if one frame out of an aggregate is lost, it may be possible to successfully receive all the remaining frames.

However, the benefits of aggregation in TGnSync are not confined to pairs. Single-receiver aggregation is required; an optional extension allows aggregate frames to contain MAC frames for multiple receivers, in which case they are called Multiple Receiver Aggregate (MRA) frames. To distinguish multiple receiver aggregate frames from single-receiver aggregate frames, multiple-receiver frames start with a control item called the Multiple Receiver Aggregate Descriptor (MRAD). The initiator's aggregate frame starts with the aggregate descriptor, and is followed by the aggregated packets for each destination. (802.11 Wireless Networks: The Definitive Guide, Second Edition”, by Matthew Gast, Second Edition, Ch. 15, April 2005 ISBN: 0-596-10052-3).

In one embodiment, the present invention provides a method to unify SMRA and MMRA to save a bit from indicating SMRA and MMRA. In one example, changes in the conventional SMRA mechanism allow MMRA to treat SMRA as a special case of MMRA, thereby unifying SMRA and MMRA. In IEEE 802.11n development process, a Multi-MCS-Multi-Receiver Aggregation (MMRA) mechanism has been proposed to increase the wireless LAN (WLAN) efficiency, as described in the TGnSync Technical Proposal in the attached Appendix.

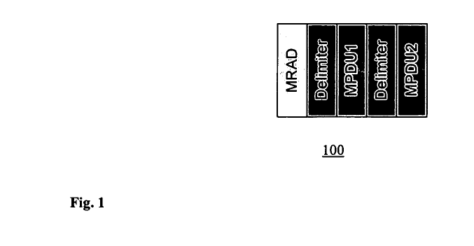

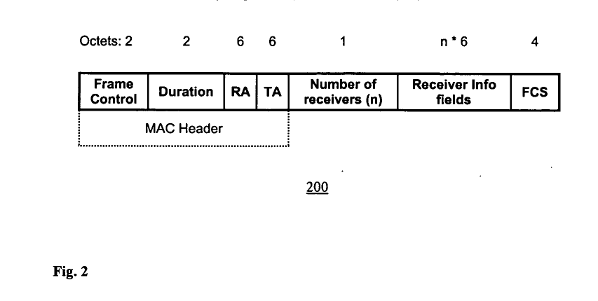

As noted, conventionally, MMRA and Single-MCS-Multi-Receiver Aggregation (SMRA) are treated as two independent communications mechanisms. SMRA provides Single Rate and Multiple Receiver Aggregation, while MMRA provides Multiple Receiver and Multiple Rate Aggregation. SMRA transmission format 100 is shown in FIG. 1, which involves the MAC layer operation. The SMRA transmission format 100 includes, in sequence: MRAD (Multiple Rate Aggregate Descriptor), Delimiter, MPDU1 (MAC protocol data unit), Delimiter and MPDU2 fields as shown in FIG. 1. The MRAD MPDU format 200 is shown in FIG. 2, and Table 1 below provides detailed information about the MRAD MPDU.

TABLE 1
Detailed information of MRAD MPDU

| | Size | |
|---|---|---|
| Field | (bytes) | Purpose |
| Frame Control | 2 | Frame type is Control. |
| Duration | 2 | |
| Receiver Address | 6 | The RA field is the broadcast group |
| | | address. |
| Transmitter Address | 6 | The TA field is the address of the |
| | | STA transmitting the MRA aggregate. |
| Number of receivers | 1 | The number of receivers (n) for |
| | | which MPDUs are included inside |
| | | the MRA aggregate. |
| Receiver Info fields | n * 6 | n Receiver Info fields, one for each |
| | | Receiver Address in the MRA aggregate. |
| FCS | 4 | |

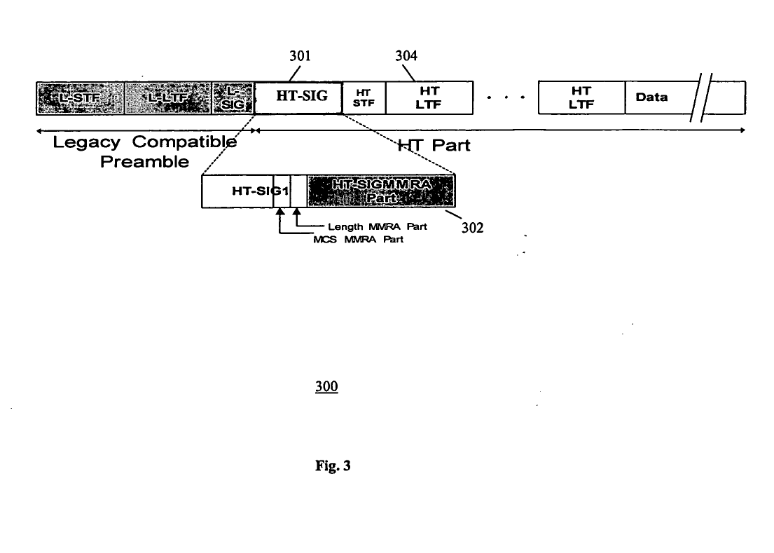

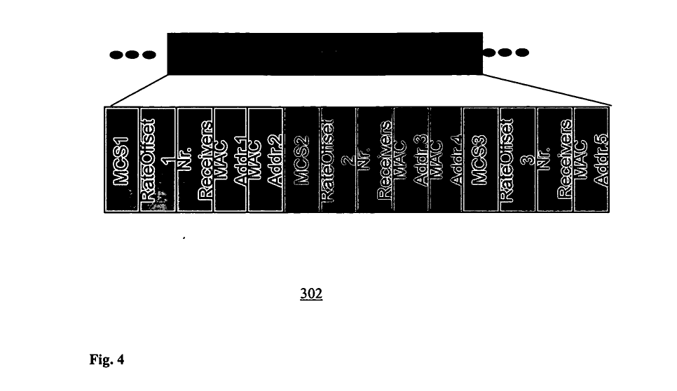

A conventional MMRA format 300 is illustrated in FIG. 3, wherein the HT-SIG-MMRA Part 302 is a middle man sitting in between PHY and MAC to enable the MMRA operation. The detail of the HT-SIG-MMRA part 302 is illustrated in FIG. 4. Because typically SMRA and MMRA are treated as two independent mechanisms, conventional solutions require at least two bits in the HT-SIG field 301 of the PLCP Protocol Data Unit (PPDU) format for MIMO transmission, to indicate the SMRA or MMRA. However, according to an embodiment of the present invention, a method is provided to unify SMRA and MMRA to save a bit while indicating SMRA and MMRA. Conventionally one bit is used to indicate MRA and an additional bit to indicate SMRA or MMRA. According to the present invention, because SMRA and MMRA are unified, only one bit is needed to indicate MRA or otherwise.

Comparing the structure of HT-SIG-MMRA part and the MRAD in SMRA, it is observed that they are almost the same except that MRAD has an additional MAC header. If the SMRA format is moved to PHY layer, the MAC header is not necessary. As such, the present invention provides a format to unify the SMRA and MMRA mechanism. By unifying the SMRA and MMRA, one bit is saved for MMRA and SMRA indication in PHY layer of HT-SIG field.

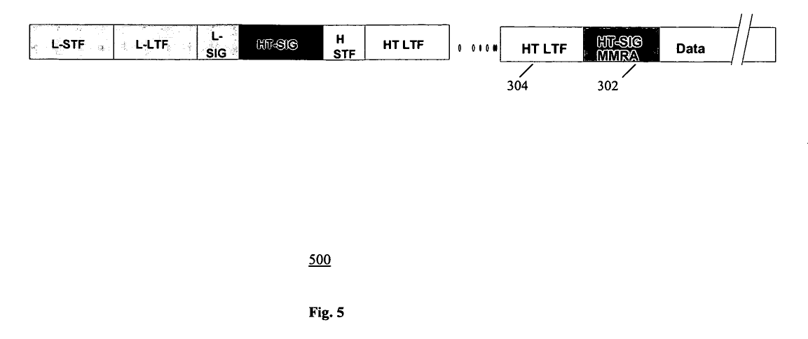

In one implementation, an improved PPDU format 500 is utilized wherein the HT-SIG-MMRA 302 is placed to the end of HT-LTF 304, as shown in FIG. 5. Commonly assigned patent application entitled “A method of implementing the ‘Multi-MCS Multi-Receiver Aggregation’ scheme in upcoming 802.11n standard”, attorney docket SAM2B.PAU.09, incorporated herein by reference, provides an example of such improved PPDU format.

In this way, the original HT-SIG format 301 (described in S.A. Mujtaba, “TGn Sync Proposal Technical Specification,” a contribution to IEEE.802.11, 11-04-889r1, November 2004, incorporated herein by reference) is maintained while accommodating the variable length of HT-SIG-MMRA 302.

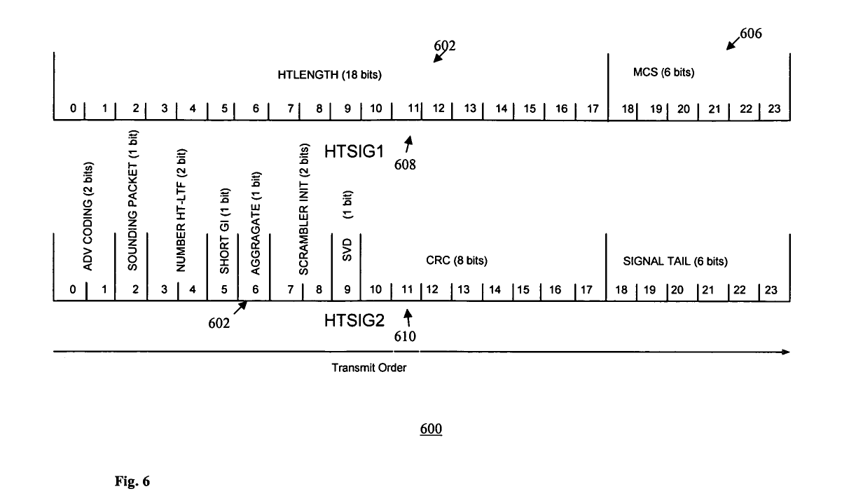

Further, referring to the HT-SIG structure 600 in FIG. 6, an AGGRAGATION bit only 602 is used in HT-SIG2 610 to indicate the MRA, whether or not the mechanism is SMRA or MMRA. In a modified PPDU format, the Length and MCS of the HT-SIG-MMRA signaling part is placed in the LENGTH field 604 and MCS field 606 of HT-SIG1 (4us) field 608, respectively, without changing the length of existing HT-SIG (8us) field 600.

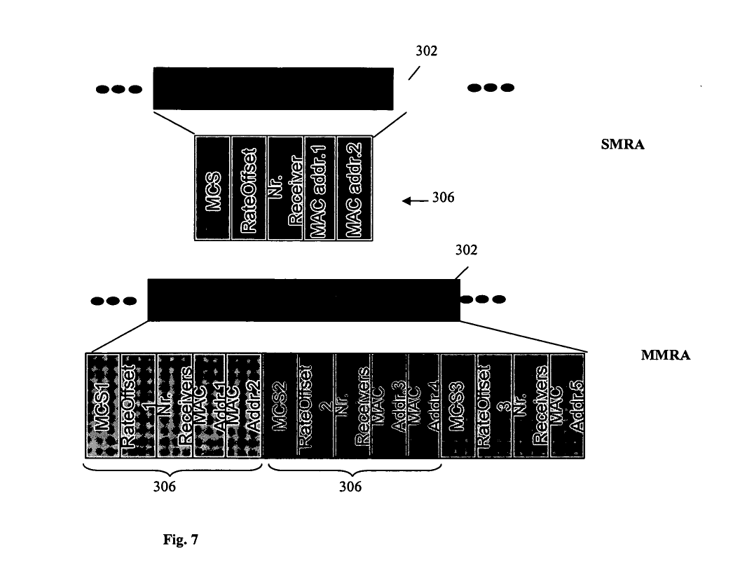

In addition, the conventional SMRA format is changed to move it from MAC layer to PHY layer, where the SMRA 306 is placed in the HT-SIG-MMRA Part 302 as shown in FIG. 7, whereby MMRA and SMRA are unified. The SMRA is treated as a special case of MMRA which is a MMRA with only one MCS set. The modified fields save on the HT-SIG bit to indicate the MRA.

The present invention has been described in considerable detail with reference to certain preferred versions thereof; however, other versions are possible. Therefore, the spirit and scope of the appended claims should not be limited to the description of the preferred versions contained herein.

What is claimed is:

1. In a method of communicating data over a wireless local area network according to an IEEE 802.11 standard for unifying Multi-MCS-Multi-Receiver Aggregation (MMRA) and Single-MCS-Multi-Receiver Aggregation (SMRA), the improvement comprising:
modifying SMRA format such that MMRA treats SMRA as a special case of MMRA, thereby unifying SMRA and MMRA.

2. The method of claim 1 wherein the steps of modifying further comprises the steps of:
providing a modified PPDU format with MMRA signaling wherein in the modified PPDU format, HT-SIG-MMRA is placed at the end of HT-LTF, whereby the HT-SIG format is preserved while accommodating the variable length of HT-SIG-MMRA.

3. The method of claim 2 wherein the step of modifying further includes the steps of:
using AGGRAGATION bit in HT-SIG such that is it used to indicate MRA whether or not the operation is SMRA or MMRA.

4. The method of claim 3 wherein the step of modifying further includes the steps of:
moving SMRA header from MAC layer to PHY layer, placed in the HT-SIG-MMRA Part, whereby SMRA is treated as a special case of MMRA which is a MMRA with only one MCS set.

5. The method of claim 4 wherein in the modified PPDU format, the Length and MCS of the HT-SIG-MMRA signaling part is placed in the LENGTH field and MCS field of HT-SIG1 (4us), respectively, without changing the length of existing HT-SIG (8us).

6. A communication system comprising:
a wireless local area network according to an IEEE 802.11 standard for unifying Multi-MCS-Multi-Receiver Aggregation (MMRA) and Single-MCS-Multi-Receiver Aggregation (SMRA), utilizing a modified SMRA format such that MMRA treats SMRA as a special case of MMRA, thereby unifying SMRA and MMRA.

7. The system of claim 6 wherein the modified PPDU includes MMRA signaling wherein in the modified PPDU format, HT-SIG-MMRA is placed at the end of HT-LTF, whereby the HT-SIG format is preserved while accommodating the variable length of HT-SIG-MMRA.

8. The system of claim 7 wherein the AGGRAGATION bit in HT-SIG is used to indicate MRA whether or not the operation is SMRA or MMRA.

9. The system of claim 8 wherein SMRA header is moved from MAC layer to PHY layer, and placed in the HT-SIG-MMRA Part, whereby SMRA is treated as a special case of MMRA which is a MMRA with only one MCS set.

10. The system of claim 9 wherein in the modified PPDU format, the Length and MCS of the HT-SIG-MMRA signaling part is placed in the LENGTH field and MCS field of HT-SIG1 (4us), respectively, without changing the length of existing HT-SIG (8us).
